(19) United States
(12) Patent Application Publication
(10) Pub. No.: US 2020/0035100 A1
(43) Pub. Date: Jan. 30, 2020

(54) DRIVING SUPPORT APPARATUS AND DRIVING SUPPORT METHOD

(71) Applicant: SONY CORPORATION, TOKYO (JP)

(72) Inventors: ATSUSHI NODA, TOKYO (JP); AKIHITO OSATO, KANAGAWA (JP); HIROTAKA SUZUKI, KANAGAWA (JP); HIDEYUKI MATSUNAGA, KANAGAWA (JP)

(21) Appl. No.: 16/496,699

(22) PCT Filed: Feb. 27, 2018
(86) PCT No.: PCT/JP2018/007214

§ 371 Date: Sep. 23, 2019

(30) Foreign Application Priority Data
Mar. 30, 2017 (JP) 2017-067390

(51) Int. Cl. G08G 1/0968; G08G 1/01; G06F 3/14; B60K 35/00; G01C 21/36

(52) U.S. Cl. CPC G08G 1/096866; G08G 1/0133; G08G 1/143; B60K 35/00; G01C 21/367; G06F 3/14

(57) ABSTRACT

A situation determining section 11 determines a situation of a vehicle on the basis of driving information. A support image setting section 13 sets a support image in accordance with a determination result obtained by the situation determining section 11. A display control section 14 executes display control for displaying the support image set by the support image setting section on a window glass of the vehicle in accordance with the determination result obtained by the situation determining section 11. The support image enables a leading operation for a running route, an emphasis operation for a traffic sign or the like, a visibility lowering operation for an outside-vehicle object that may cause lowering of attentiveness of the driven vehicle, and the like, and driving support can be executed with a natural sense.

### TECHNICAL FIELD

The present technology relates to a driving support apparatus and a driving support method, and enables execution of driving support with which driving support can be executed with a natural sense.

### BACKGROUND ART

Support for driving is conventionally executed by projecting an image onto a portion of the windshield of a vehicle. For example, in PTL 1, an image that prompts an operation to accelerate or decelerate using an expression by a diagram is caused to be projected onto a portion of the windshield of the own vehicle such that this image is displayed to be superimposed on the scenery that the driver can see, and information that prompts an operation to accelerate or decelerate is thereby notified.

### CITATION LIST

### Patent Literature

### [PTL 1]

Japanese Patent Laid-Open No. 2016-146096

### SUMMARY

### Technical Problems

Incidentally, in PTL 1, the information notified is limited and only part of the information necessary for driving can be acquired. Moreover, the image indicating the information necessary for driving is projected at a lower right corner portion of the windshield such that any move of the line of sight of the driver from the front of the driver (the travelling direction of the own vehicle) is suppressed as far as possible. Because of this, when the driver checks the information, the driver needs to move the viewpoint in an unnatural manner different from the case of driving, and the attention of the driver may be distracted.

An object of the present technology is therefore to provide a driving support apparatus and a driving support method that enable execution of driving support with a natural sense.

### Solution to Problems

A first aspect of this technology resides in a driving support apparatus including:

a situation determining section determining a situation of a vehicle on the basis of driving information;

a support image setting section setting a support image in accordance with a determination result obtained by the situation determining section; and

a display control section executing display control for displaying the support image set by the support image setting section on a window glass of the vehicle in accordance with the determination result obtained by the situation determining section.

In this technology, the situation determining section executes determination as to the situation of the vehicle on the basis of the driving information. The support image setting section makes the setting for the support image in accordance with the determined situation and, in a case where it is determined that the vehicle is, for example, in a running operation, sets a leading vehicle image as the support image. The display control section displays the set support image on, for example, the windshield of the vehicle. Moreover, the display position of the support image is controlled in accordance with the situation determination result. For example, when it is determined that the vehicle is in a running operation using route information, the display control section controls the display position of the support image in accordance with the route information to display the support image such that the leading vehicle image is placed at a position on the cruising lane based on the route information. Moreover, at a road connection point associated with a right or left turn or a change of the cruising lane, when the distance to the road connection point is within a predetermined range, the display control section executes the display of the leading vehicle image and controls the display position of the leading vehicle image such that the leading vehicle image is placed at a position on the cruising lane at the time of making a right or left turn or on the changed cruising lane on the basis of the route information. Moreover, the display control section moves the display position of the leading vehicle image in accordance with the running speed indicated by the driving information, and sets the size of the leading vehicle image and/or controls the display position of the leading vehicle image in accordance with the acceleration or deceleration information indicated by the driving information. Furthermore, the display control section may display the leading vehicle image when the running location is within a predetermined zone.

Moreover, in a case where the driving support apparatus further includes an outside condition determining section determining the outside condition on the basis of outside-vehicle information, the support image setting section sets a support image in accordance with the determination result of the situation and/or the outside condition, and the display control section controls the display position of the support image in accordance with the determination result of the situation and/or the outside condition. For example, in a case where it is determined that the vehicle is in a running operation, a leading vehicle image is set as the support image, a displayable area for the leading vehicle image is determined on the basis of the outside condition determined by the outside condition determining section, and the leading vehicle image is displayed in the determined displayable area.

Moreover, in a case where it is determined that the vehicle is entering a parking lot, the display control section displays the leading vehicle image at a position on a route to a vacant space in the parking lot determined by the outside condition determining section. Moreover, in a case where the outside condition determining section determines that visibility is low, the display control section displays the leading vehicle image at a position on the cruising lane of the vehicle. Moreover, the outside condition determining section determines the inter-vehicle distance to a preceding vehicle, and makes a setting for the attribute of the leading vehicle image or executes control for the display position of the leading vehicle image in accordance with the determined inter-vehicle distance.

Moreover, the outside condition determining section executes determination as to a traffic safety facility, the support image setting section sets a supplementary image that emphasizes display of the traffic safety facility determined by the outside condition determining section, and, when the outside condition determining section determines the traffic safety facility, the display control section displays the supplementary image using the position of the determined traffic safety facility as a criterion.

Moreover, in a case where the situation determining section determines that the vehicle is in a running operation, the support image setting section sets a filter image as the support image, the outside condition determining section executes determination as to an outside-vehicle object that may cause lowering of the attentiveness of the driver, and the display control section displays the filter image at a position of the outside-vehicle object determined by the outside condition determining section to possibly cause lowering of the attentiveness of the driver.

A second aspect of the present technology resides in a driving support method including:

by a situation determining section, determining a situation of a vehicle on the basis of driving information;

by a support image setting section, setting a support image in accordance with a determination result obtained by the situation determining section; and

by a display control section, executing display control for displaying the support image set by the support image setting section on a window glass of the vehicle in accordance with the determination result obtained by the situation determining section.

### Advantageous Effect of Invention

According to the present technology, the situation of the vehicle is determined by the situation determining section on the basis of the driving information, and the support image is set by the support image setting section in accordance with the determination result obtained by the situation determining section. Furthermore, the display control for the support image set by the support image setting section is executed by the display control section on an outside-vehicle visual recognition face of the vehicle in accordance with the determination result obtained by the situation determining section. The driving support can therefore be executed with a natural sense. Note that the effects described in the present specification are merely exemplification and not limitative, and any additional effects may be achieved.

### BRIEF DESCRIPTION OF DRAWINGS

FIG. 1 depicts a configuration of a driving support apparatus.

FIG. 2 is a flowchart exemplifying an operation of the driving support apparatus.

FIG. 3 is a flowchart exemplifying an operation of the driving support apparatus that includes an outside condition determining section.

FIG. 4 is a block diagram depicting an example of schematic configuration of a vehicle control system.

FIG. 5 is a diagram of assistance in explaining an example of installation positions of an outside-vehicle information detecting section and an imaging section.

FIG. 6 is a diagram exemplifying a fact that the positional relation between an outside-vehicle object and a support image is varied depending on the position of the viewpoint of a driver.

FIG. 7 is a diagram exemplifying a case where a running operation is being executed.

FIG. 8 is a diagram exemplifying a case where a running operation based on route information is being executed.

FIG. 9 is a diagram exemplifying a case where the vehicle is to be parked.

FIG. 10 is a diagram exemplifying a case where a running operation is being executed in a state of low visibility.

FIG. 11 is a diagram exemplifying a case where a display operation for a support image is controlled in accordance with an inter-vehicle distance.

FIG. 12 is a diagram exemplifying a case where a new image is added to a support image and a case where an attribute of the support image is set.

FIG. 13 is a diagram exemplifying a case where a support image facilitating recognition of information necessary for driving is displayed.

FIG. 14 is a diagram exemplifying a case where a support image capable of preventing lowering of attentiveness of the driver is displayed.

### DESCRIPTION OF EMBODIMENT

A mode to implement the present technology will be described below. Note that the description will be made in the following order.

1. Configuration and Operation of Driving Support Apparatus

2. Configuration and Operation of Vehicle Equipped with Driving Support Apparatus

<1. Configuration and Operation of Driving Support Apparatus>

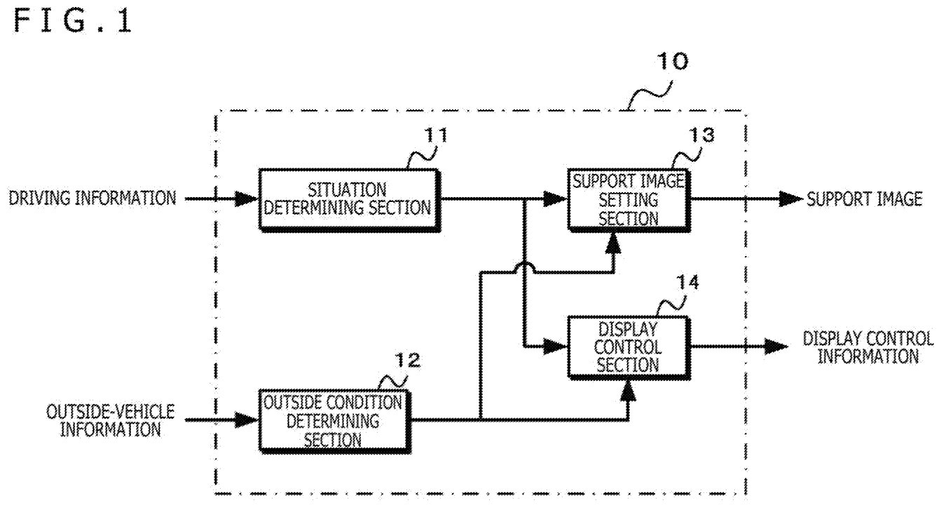

FIG. 1 exemplifies a configuration of a driving support apparatus of the present technology. The driving support apparatus 10 includes a situation determining section 11, a support image setting section 13, and a display control section 14. In addition, the driving support apparatus 10 may further include an outside condition determining section 12.

The situation determining section 11 determines the situation of a vehicle on the basis of driving information. The situation determining section 11 determines in what situation the vehicle is, for example, whether or not the vehicle is currently running, to what extent the vehicle is accelerating or decelerating, at what location the vehicle is currently running, in what route the vehicle is planned to run, or the like, on the basis of the driving information (the current location of the vehicle, the running speed, the acceleration, and the route information, for example), and outputs the determination result to the support image setting section 13.

The support image setting section 13 sets a support image in accordance with the determination result obtained by the situation determining section 11. For example, in a case where the vehicle is in a running operation based on the route information, the support image setting section 13 sets an image indicating a leading vehicle as a pictorial figure (a leading vehicle image) as a support image. Note that the support image is set to be a translucent image, an image constituted by only profile lines, or the like such that the field of view is not blocked by displaying the support image on a window glass of the vehicle. The support image setting section 13 outputs an image signal of the set support image to a display section.

The display control section 14 generates display control information in accordance with the determination result obtained by the situation determining section 11, outputs the display control information to the display section, and executes display control for the support image set by the support image setting section 13 on the window glass of the vehicle. For example, in a case where the vehicle is currently running or in a case where the running location is within a predetermined zone, the display control section 14 executes the display control such that the leading vehicle image set by the support image setting section 13 is displayed in front of the driver on the windshield. Further, in a case where the vehicle is currently in a running operation using the route information, the display control section 14 controls the display position of the support image in accordance with the route information. Moreover, the display control section 14 may execute the display control for the support image in accordance with the running speed or acceleration or deceleration of the vehicle.

Further, in a case where the outside condition determining section 12 is provided, the outside condition determining section 12 determines the condition of the surroundings of the vehicle on the basis of outside-vehicle information (a captured forward image captured by an imaging section that is disposed on the vehicle, and surrounding information and captured surrounding image acquired from external devices through communication or the like, for example). For example, the outside condition determining section 12 executes determination as to a vacant space in a parking lot, determination as to the state of the field of view, and determination as to a traffic safety facility (a traffic sign, a traffic signal, and a traffic information display board, for example). The support image setting section 13 sets a support image in accordance with the determination results obtained by the situation determining section 11 and/or the outside condition determining section 12. For example, the support image setting section 13 sets a leading vehicle image, a supplementary image that emphasizes the display of a traffic safety facility as described later, and the like. Further, the display control section 14 generates display control information and executes display of the support image and control for the display position in accordance with the determination results obtained by the situation determining section 11 and/or the outside condition determining section 12.

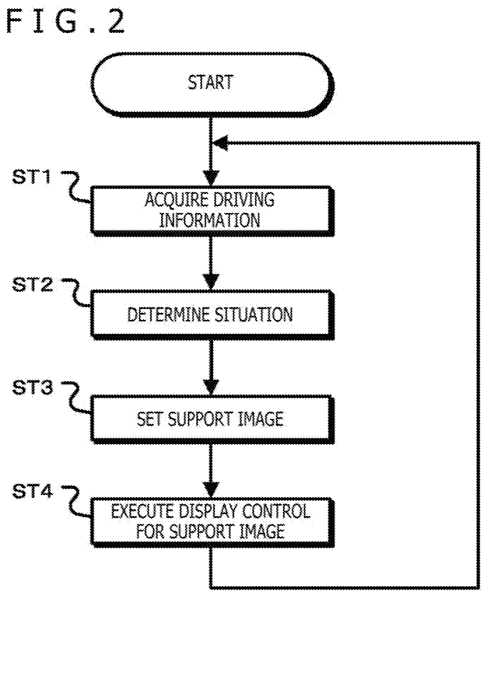

FIG. 2 is a flowchart exemplifying an operation of the driving support apparatus. At step ST1, the driving support apparatus acquires driving information. The driving support apparatus acquires the driving information from the vehicle and advances the operation to step ST2.

At step ST2, the driving support apparatus determines the situation. The situation determining section 11 of the driving support apparatus determines in what situation the vehicle currently is, on the basis of the driving information acquired at step ST1, and advances the operation to step ST3.

At step ST3, the driving support apparatus sets a support image. The support image setting section 13 of the driving support apparatus sets a support image in accordance with the situation determined at step ST2, for example, sets a leading vehicle image as a support image at the time of a running operation of the vehicle, and advances the operation to step ST4.

At step ST4, the driving support apparatus executes display control for the support image. The display control section 14 of the driving support apparatus executes display control for the support image set at step ST3 in accordance with the situation determined at step ST2, for example, displays a leading vehicle image on the windshield at the time of a running operation of the vehicle, and returns the operation to step ST1.

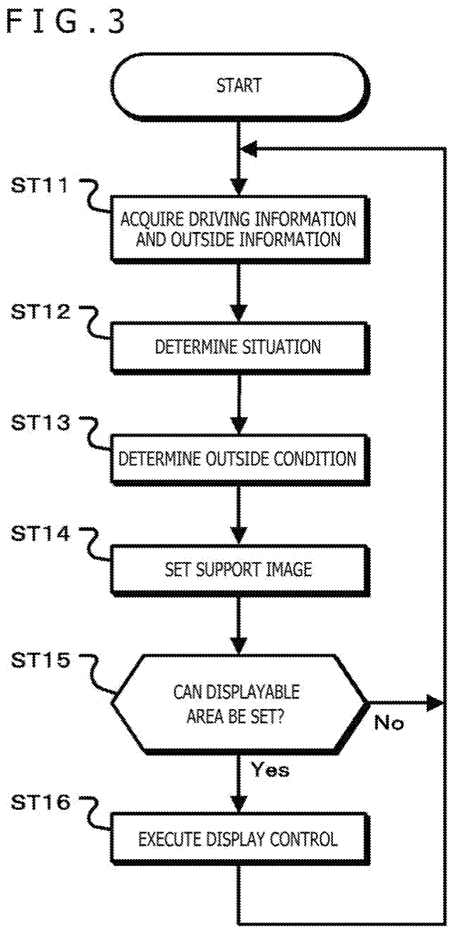

FIG. 3 is a flowchart exemplifying an operation of the driving support apparatus that includes the outside condition determining section. At step ST11, the driving support apparatus acquires driving information and outside information. The driving support apparatus acquires the driving information and the outside information from the vehicle and advances the operation to step ST12.

At step ST12, the driving support apparatus determines the situation. The situation determining section 11 of the driving support apparatus determines in what situation the vehicle currently is on the basis of the driving information acquired at step ST11 and advances the operation to step ST13.

At step ST13, the driving control section determines the outside condition. The outside condition determining section 12 of the driving support apparatus executes determination as to the outside environment of the vehicle, an outside-vehicle object that may cause lowering of attentiveness of the driver (a tourist facility and an advertisement display, for example), or the like on the basis of the driving information acquired at step ST11, and advances the operation to step ST14.

At step ST14, the driving support apparatus sets a support image. The support image setting section 13 of the driving support apparatus sets a support image in accordance with the situation determined at step ST12 and/or the outside condition determined at step ST13. For example, while running, the support image setting section 13 sets, as a support image: a leading vehicle image in a case where the visibility is lowered due to fog, rain, snow, or the like; a supplementary image in a case where a traffic safety facility is determined; a filter image that lowers the visibility of an outside-vehicle object in a case where the outside-vehicle object that may cause lowering of the attentiveness of the driver is determined; and the like. The operation is then advanced to step ST15.

At step ST15, the driving support apparatus determines whether or not a displayable area of the support image can be set. The display control section 14 of the driving support apparatus determines whether or not a displayable area of the support image can be set, on the basis of the outside information acquired at step ST11. In a case where the displayable area can be set, the display control section 14 advances the operation to step ST16 and, in a case where the displayable area cannot be set, the display control section 14 returns the operation to step ST11.

At step ST16, the driving support apparatus executes display control. The display control section 14 of the driving support apparatus displays the support image set at step ST14 in the displayable area set at step ST15, in accordance with the situation determined at step ST12 and the outside condition determined at step ST13. For example, the display control section 14 displays a leading vehicle image in an area between a preceding vehicle and the own vehicle on the windshield as the displayable area for the support image, during the running operation of the vehicle, and returns the operation to step ST11. Further, the display control section 14 executes display control by superimposing a filter image at a position of an outside-vehicle object that may cause lowering of the attentiveness of the driver to lower the visibility, and returns the operation to step ST11.

As above, in the present technology, the situation of the vehicle is determined by the situation determining section on the basis of the driving information and the support image setting section sets the support image in accordance with the determination result. Further, the display control for the support image set by the support image setting section is executed for a window glass of the vehicle, in accordance with the determination result obtained by the situation determining section. The driving support can therefore be executed with a natural sense. Moreover, in a situation or an outside condition where no support image is necessary, the display of the support image is ended and the driving support can therefore be executed as needed.

<2. Configuration and Operation of Vehicle Equipped with Driving Support Apparatus>

A case will next be described where the technology according to the present disclosure is provided in any type of vehicle such as a car, an electric car, a hybrid electric car, or a motorcycle.

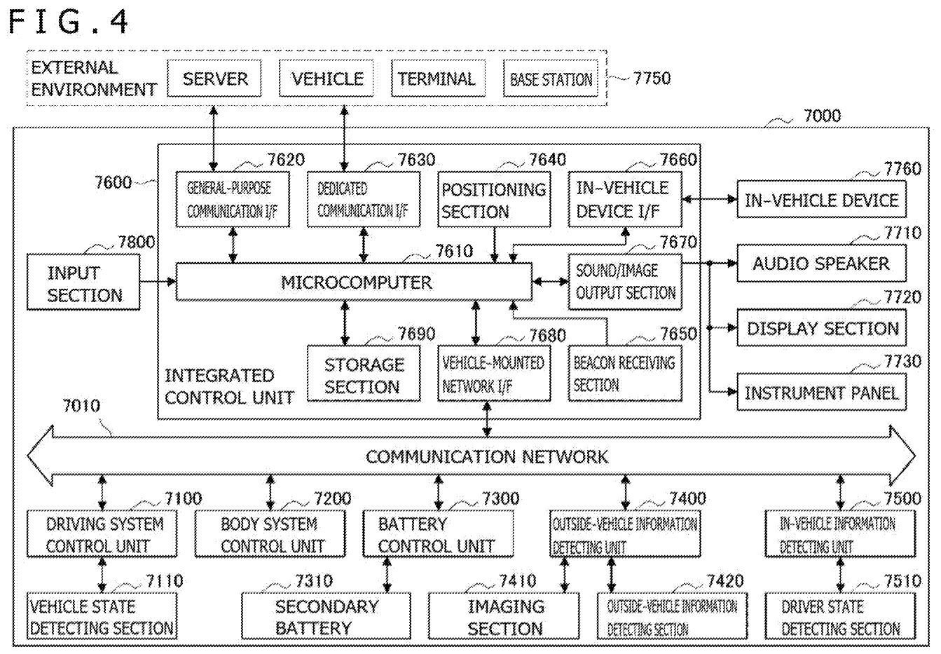

FIG. 4 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 4, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay, or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 4 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

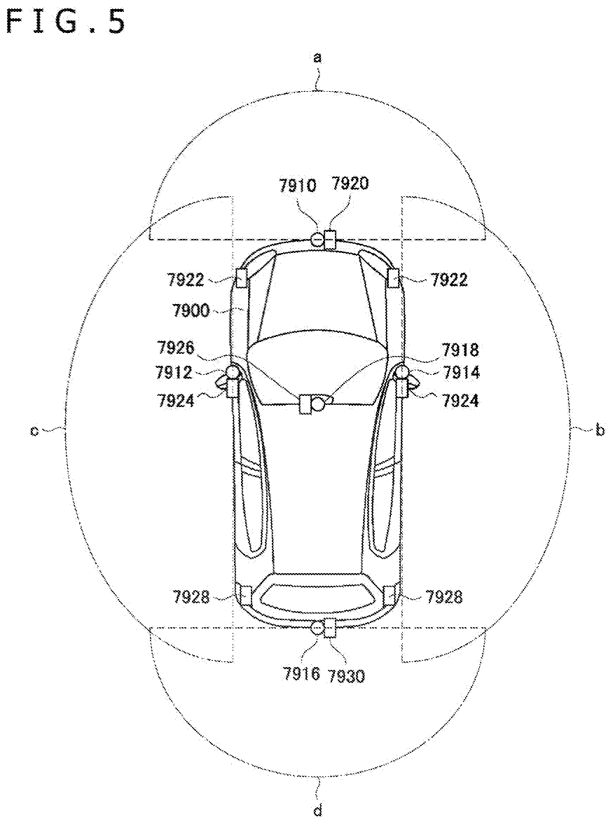

FIG. 5 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 5 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 4, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM), worldwide interoperability for microwave access (WiMAX), long term evolution (LTE)), LTE-advanced (LTE-A), or the like, or another wireless communication protocol such as wireless LAN (referred to also as wireless fidelity (Wi-Fi), Bluetooth, or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth, near field communication (NFC), or wireless universal serial bus (WUSB). In addition, the in-vehicle device I/F 7660 may establish wired connection by universal serial bus (USB), high-definition multimedia interface (HDMI), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automatic driving, which makes the vehicle to travel autonomously without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 4, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 4 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

In a case where the driving support apparatus of the present technology is provided in the vehicle control system 7000 depicted in FIG. 4, the information detected by the vehicle state detecting section 7110, the location information acquired by the positioning section 7640, the map information stored in the storage section 7690, and the route information generated using the map information are used as the driving information. Further, the captured image acquired by the imaging section 7410, the detection information indicating the detection result obtained by the outside-vehicle information detecting section 7420, the information acquired from external devices through the general-purpose communication I/F 7620 and the dedicated communication I/F 7630, and the like are used as the outside information. Further, the microcomputer 7610 has the functions of the situation determining section 11, the support image setting section 13, and the display control section 14. The display section 7720 displays the support image set by the support image setting section 13 at the display position based on the display control information from the display control section 14. For example, the display section 7720 has the function of displaying the support image on the window glass, and the function of changing the display position of the support image on the basis of an instruction from the display control section 14. In addition, in the vehicle control system 7000, the support image is projected onto the window glass by providing, for example, an image projecting function in the display section 7720, thereby displaying the support image on the window glass.

The microcomputer 7610 executes the processes at the steps depicted in FIG. 2, sets the support image in accordance with the determination result for the situation of the vehicle that is based on the driving information, displays the set support image on, for example, the windshield of the vehicle, and thereby executes the driving support with a natural sense.

Further, in a case where the microcomputer 7610 further has the function of the outside condition determining section 12, the microcomputer 7610 executes the processes at the steps depicted in FIG. 3, and sets the support image in accordance with the determination result for the situation of the vehicle based on the driving information and the outside condition determination result. Further, the microcomputer 7610 executes the display control to display the set support image on the windshield or the like of the vehicle.

An exemplary operation of the microcomputer 7610 will next be described. The microcomputer 7610 uses, as the driving information, the speed, the acceleration, the operation of the accelerator pedal, the operation of the brake pedal, the steering of the steering wheel, the engine speed or the rotation speed of the wheels, and the like of the vehicle detected by the vehicle state detecting section 7110, the location information indicating the current location acquired by the positioning section 7640, the map information stored in the storage section 7690, and the route information generated using the map information. The microcomputer 7610 determines the situation of the vehicle on the basis of the driving information. The microcomputer 7610 determines the situation, for example, determines whether or not the situation is the running operation in accordance with the operation by the driver, the engine speed, the speed of the vehicle, and the like, determines whether or not the situation is entrance into a parking lot on the basis of the location information and the map information, determines whether or not the situation is the running operation based on the route information, or the like.

Moreover, the microcomputer 7610 determines the outside condition on the basis of the captured image acquired by the imaging section 7410, the detection information indicating the detection result obtained by the outside-vehicle information detecting section 7420, the information acquired from external devices through the general-purpose communication I/F 7620 and the dedicated communication I/F 7630, and the like. For example, the microcomputer 7610 executes determination as to the field of view on the basis of the captured image and the environment recognition process result, determination as to the distance to the preceding vehicle (the inter-vehicle distance) detected by an ultrasonic sensor, a radar device, a LIDAR device, or the like, and determination as to a traffic safety facility on the basis of the captured image, the road-to-vehicle communication, and the like.

The microcomputer 7610 sets the support image in accordance with the determined situation. For example, in a case where the vehicle is in a running operation based on the route information, the microcomputer 7610 sets a leading vehicle image as the support image. Note that the support image is set to be, for example, a translucent image, an image constituted by only profile lines, or the like such that the forward field of view is not blocked by displaying the support image on the windshield. Furthermore, the microcomputer 7610 executes display control for the support image on the window glass of the vehicle and, in a case, for example, where the vehicle is currently running or where the vehicle is in an accelerating or decelerating state, executes display control such that the leading vehicle image is displayed in front of the driver on the windshield. In a case where the vehicle is in a running operation using the route information, the microcomputer 7610 controls the display position of the support image in accordance with the route information.

Moreover, the microcomputer 7610 determines the condition of the surroundings of the vehicle on the basis of the outside-vehicle information (the captured forward image captured by the imaging section disposed in the vehicle, the surrounding information and the captured surrounding image acquired from external devices through communication or the like, for example). The microcomputer 7610 executes, for example, determination as to a vacant space in a parking lot, determination as to the state of the field of view and a traffic safety facility, and the like and sets the support image in accordance with the situation determination result and/or the outside condition determination result. The microcomputer 7610 sets, for example, a leading vehicle image and a supplementary image that emphasizes the display of a traffic safety facility. Moreover, the microcomputer 7610 executes control for the display of the support image, or the display and the display position of the support image in accordance with the situation determination result and/or the outside condition determination result.

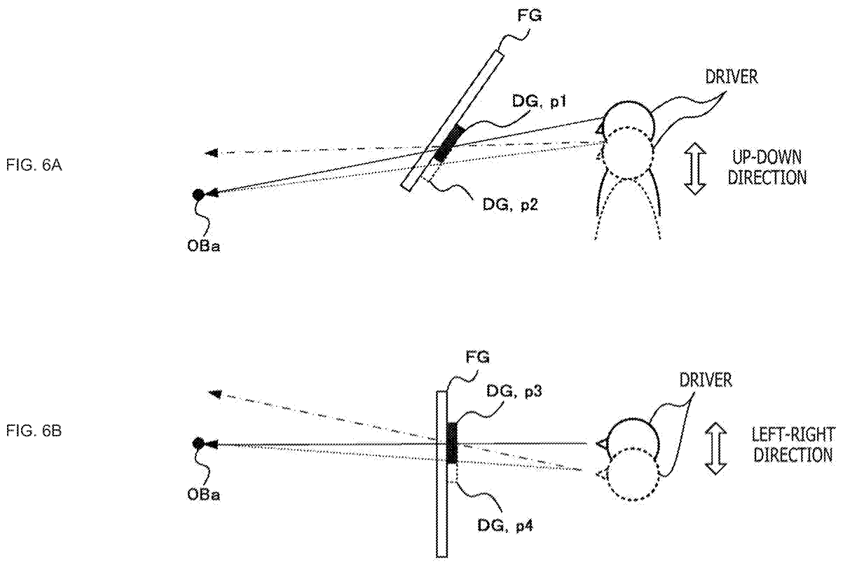

In the control for the display position of the support image, the support image is caused to be displayed at a position that is proper when seen from the driver. The position of the viewpoint of the driver is varied depending on the seating height of the driver, the position of the seat on which the driver is seated in the front-back direction, and the amount of reclining of the seat. In a case where the support image is displayed on the windshield, for example, the positional relation between an outside-vehicle object that can be visually recognized through the windshield and the support image is therefore varied depending on the position of the viewpoint of the driver. FIG. 6 exemplifies the fact that the positional relation between the outside-vehicle object and the support image is varied depending on the position of the viewpoint of the driver. Note that (a) of FIG. 6 exemplifies a case where the viewpoint moves in the up-down direction and (b) of FIG. 6 exemplifies a case where the viewpoint moves in the left-right direction. In (a) of FIG. 6, in a case where a support image DS is displayed at a position p1 on the windshield FG at which an outside-vehicle object OB is visually recognized from the viewpoint of the driver indicated by a solid line, with the viewpoint of the driver indicated by a dotted line, the position of the support image DS is in a more upward direction as indicated by a dashed-dotted line than the position of the outside-vehicle object OB. Further, in (b) of FIG. 6, in a case where a support image DS is displayed at a position p3 on the windshield FG at which an outside-vehicle object OB is visually recognized from the viewpoint of the driver indicated by a solid line, with the viewpoint of the driver indicated by a dotted line, the position of the support image DS is in a more rightward direction as indicated by a dashed-dotted line than the position of the outside-vehicle object OB.

Because the positional relation between the outside-vehicle object and the support image is varied depending on the position of the viewpoint of the driver in this manner, the driver state detecting section 7510 acquires the seating height of the driver, the position of the seat on which the driver is seated in the front-back direction, the amount of reclining of the seat, and the like as the driver information, and detects the position of the viewpoint of the driver on the basis of the driver information. Moreover, the driver state detecting section 7510 may detect the position of the viewpoint by detecting the positions of the eyes of the driver from an image captured of the driver. The microcomputer 7610 determines the display position of the support image to be displayed on the windshield on the basis of the position of the viewpoint of the driver detected by the driver state detecting section 7510 and executes the display of the support image. For example, with the viewpoint of the driver indicated by the dotted line in (a) of FIG. 6, the support image is displayed at a position p2 in a more downward direction than the position p1 and, with the viewpoint of the driver indicated by the dotted line in (b) of FIG. 6, the support image is displayed at a position p4 in a more leftward direction than the position p3.

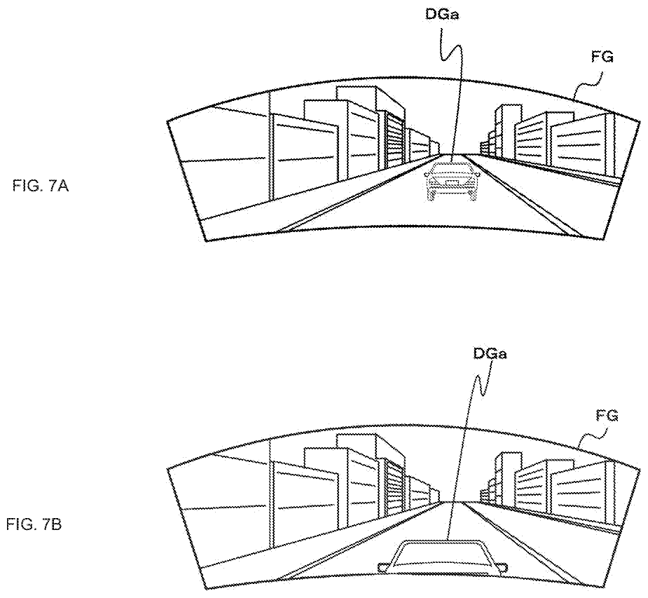

Exemplary displays of the support image will next be described. FIG. 7 is a diagram exemplifying a case where a running operation is being executed, and a leading vehicle image is displayed as the support image. For example, in a case where the microcomputer 7610 determines that a running operation is being executed, on the basis of the detection result such as the running speed obtained by the vehicle state detecting section 7110, the microcomputer 7610 controls the display position of the leading vehicle image in accordance with the running speed. Moreover, the microcomputer 7610 controls the display position of the leading vehicle image in accordance with the running speed of the own vehicle and the speed limit, on the basis of the speed limit indicated by a traffic sign determined from a captured image captured by, for example, the imaging section 7910 or the imaging section 7918 depicted in FIG. 5, or speed limit information acquired from an external device using the general-purpose communication I/F 7620 or the dedicated communication I/F 7630. As depicted in (a) of FIG. 7, the microcomputer 7610 displays a leading vehicle image DSa on the cruising lane of the own vehicle that can be seen through the windshield FG from the viewpoint of the driver. Moreover, in a case where the running speed is higher than the speed limit, as depicted in (b) of FIG. 7, the microcomputer 6710 moves the display position of the leading vehicle image DSa to the side closer to the driver (in the downward direction on the windshield FG). This enables the driver to determine whether or not the running speed exceeds the speed limit, by the display position of the leading vehicle image DSa.

Moreover, the microcomputer 7610 may set the size of the leading vehicle image in the support image setting section and/or execute control for the display position of the leading vehicle image in the display control section, in accordance with the acceleration or deceleration information detected by the vehicle state detecting section 7110. For example, in a case where the microcomputer 7610 determines a rapid acceleration, the microcomputer 7610 may enlarge the size of the leading vehicle image DSa as if the own vehicle approaches the leading vehicle, or may control the display position of the leading vehicle image DSa such that it is recognized that the leading vehicle image DSa has approached the driver. In this manner, the microcomputer 7610 can attract attention of the driver not to execute a rapid acceleration, by setting the size of the leading vehicle image and/or controlling the display position of the leading vehicle image.

Moreover, the microcomputer 7610 may display the leading vehicle image DSa when the vehicle runs in a predetermined zone. For example, in a case where information relating to a dangerous zone in which accidents and speeding often occur has been acquired from an external device or the like, the microcomputer 7610 executes the driving support by displaying the leading vehicle image DSa when the current location acquired by the positioning section 7640 runs in the dangerous zone, thereby enabling prevention of any accident or speeding.

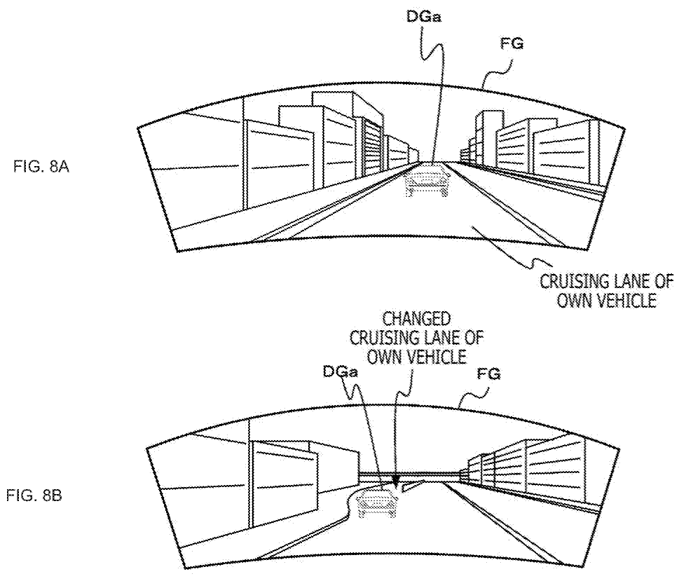

FIG. 8 is a diagram exemplifying a case where a running operation based on the route information is being executed, and displays a leading vehicle image as the support image. The microcomputer 7610 determines the cruising lane of the own vehicle on the basis of the route information and the map information stored in the storage section 7690 and the location information indicating the current location acquired by the positioning section 7640. Furthermore, as depicted in (a) of FIG. 8, the microcomputer 7610 displays a leading vehicle image DSa on the cruising lane of the own vehicle that can be seen from the viewpoint of the driver through the windshield FG. Moreover, the microcomputer 7610 determines a road connection point associated with a right or left turn, or a change of the cruising lane on the basis of the route information and the map information and the location information indicating the current location acquired by the positioning section 7640. As depicted in (b) of FIG. 8, at the determined road connection point, the microcomputer 7610 displays the leading vehicle image DSa to be at a position on the cruising lane taken after the change (the changed cruising lane of the own vehicle) that can be seen through the windshield FG from the viewpoint of the driver, that is, at a position on the cruising lane taken when a right or left turn is made or on the changed cruising lane of the own vehicle on the basis of the route information. With such a support image displayed, the driver can easily arrive at the destination by executing the driving control such that the own vehicle follows the leading vehicle indicated by the support image. Moreover, the microcomputer 7610 may display the leading vehicle image DSa when the distance to the road connection point associated with a right or left turn, or a change of the cruising lane is within a predetermined range. In this case, because the leading vehicle image DSa is displayed in a case where the change of the cruising lane is necessary, the leading vehicle image DSa can be set not to be displayed in a case where the necessity of the driving support is low.

A case will next be described where the outside condition is determined on the basis of the outside-vehicle information and the display control for the support image is executed in accordance with the determination results of the situation and the outside condition. For example, in a case where the situation determining section determines that the vehicle is in a running operation, the support image setting section sets a leading vehicle image as the support image and the display control section executes the display control for the leading vehicle image on the basis of the outside condition determined by the outside condition determining section.

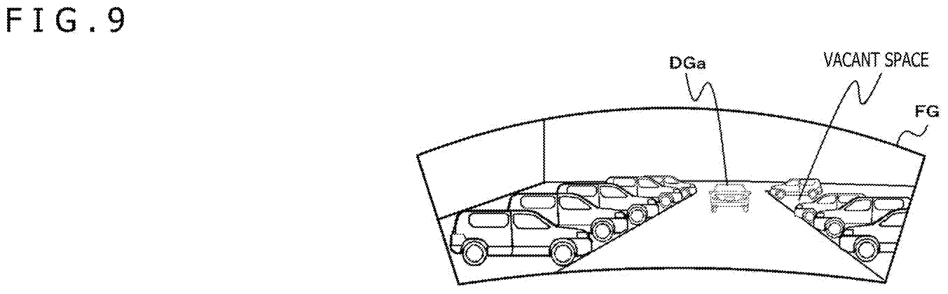

FIG. 9 is a diagram exemplifying a case where the vehicle is to be parked and depicts a leading vehicle image as the support image. The microcomputer 7610 determines that the vehicle is running in a parking lot on the basis of, for example, the map information stored in the storage section 7690 and the location information indicating the current location acquired by the positioning section 7640. Moreover, the microcomputer 7610 acquires a map of the inside of the parking lot and vacant space information as the outside information from external devices through the general-purpose communication I/F 7620 and the dedicated communication I/F 7630, and determines a route to a vacant space. Furthermore, the microcomputer 7610 displays a leading vehicle image DSa on the route to the vacant space that can be seen through the windshield FG from the viewpoint of the driver or at the position of the vacant space. With such a support image displayed, the driver is enabled to easily park the vehicle by executing the driving control such that the vehicle follows the leading vehicle indicated by the support image.

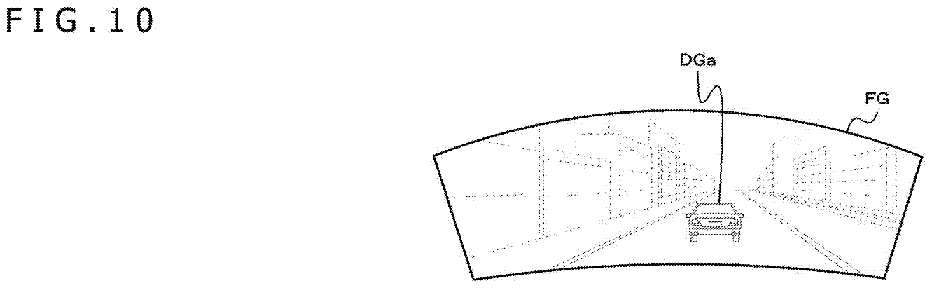

FIG. 10 is a diagram exemplifying a case where a running operation is being executed in the state of low visibility, and a leading vehicle image is displayed as the support image. The microcomputer 7610 determines whether or not the visibility is low using, for example, a captured image captured by the imaging section 7910 or the imaging section 7918 depicted in FIG. 5 as the outside information. Moreover, the microcomputer 7610 determines the cruising lane of the own vehicle on the basis of the map information stored in the storage section 7690 and the location information indicating the current location acquired by the positioning section 7640. Furthermore, in a case where the microcomputer 7610 determines that the visibility is low, as depicted in FIG. 10, the microcomputer 7610 displays a leading vehicle image DSa on the cruising lane of the own vehicle that can be seen from the viewpoint of the driver through the windshield FG. With such a support image displayed, the driver is enabled to control the vehicle to run without departing from the cruising lane of the own vehicle even when the visibility is low by executing the driving control such that the vehicle follows the leading vehicle indicated by the support image.

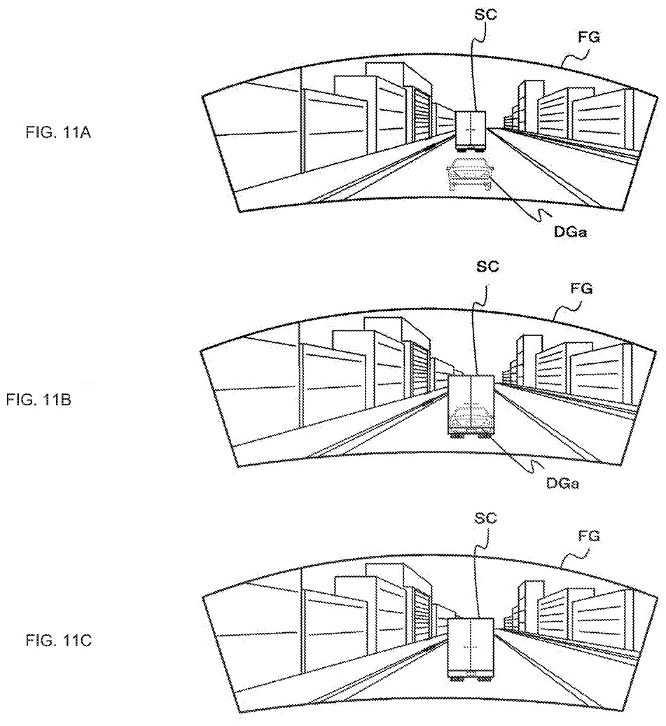

Moreover, the microcomputer 7610 may determine a displayable area for a leading vehicle image on the basis of the outside condition and may display the leading vehicle image in the determined displayable area. In a case where the microcomputer 7610 displays a leading vehicle image as the support image on the cruising lane of the own vehicle, the microcomputer 7610 determines whether or not a displayable area for the leading vehicle image can be provided, in accordance with the inter-vehicle distance to a preceding vehicle and the forward running environment. In a case where he microcomputer 7610 determines that the displayable area can be provided, the microcomputer 7610 displays the leading vehicle image in the displayable area and, in a case where the microcomputer 7610 determines that a displayable area cannot be provided, the microcomputer 7610 does not display the leading vehicle image. FIG. 11 exemplifies a case where the display operation of the support image is controlled in accordance with the inter-vehicle distance. The microcomputer 7610 determines the inter-vehicle distance to the preceding vehicle detected by, for example, an ultrasonic sensor, a radar device, a LIDAR device, or the like. In a case where the inter-vehicle distance is longer than, for example, a predetermined distance, as depicted in (a) of FIG. 11, the microcomputer 7610 sets an area on the cruising lane of the own vehicle that can be seen from the viewpoint of the driver through the windshield FG and between the own vehicle and a preceding vehicle SC, to be the displayable area and displays a leading vehicle image DSa in this area. In a case where the inter-vehicle distance is equal to or shorter than the predetermined distance, when the microcomputer 7610 displays the leading vehicle image DSa, as depicted in (b) of FIG. 11, the leading vehicle image DSa is displayed at the position of the preceding vehicle SC and it is difficult to check the running condition of the preceding vehicle SC. Therefore, in a case where a displayable area cannot be provided because the inter-vehicle distance is equal to or shorter than the predetermined distance, as depicted in (c) of FIG. 11, the microcomputer 7610 does not display the leading vehicle image DSa. Further, in a case where the own vehicle is stopped at a head position at an intersection or a case where a pedestrian is crossing the road in front of the own vehicle, if the leading vehicle image DSa is displayed, this results in display of an image not suitable for the actual environment. In this case, the microcomputer 7610 therefore does not display the leading vehicle image DSa. With such a display control for the support image executed, a support image that does not lower the visibility of a vehicle running ahead and that is suitable for the actual environment can be provided to the driver.

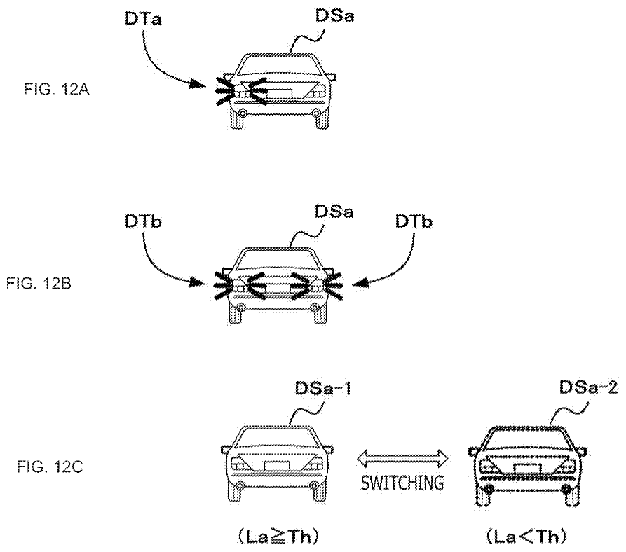

Moreover, the microcomputer 7610 may add a new image to the support image in accordance with the situation or may set an attribute of the support image. FIG. 12 exemplifies a case where a new image is added to the support image and a case where an attribute of the support image is set. For example, in a case where a change of the cruising lane is executed, as depicted in (a) of FIG. 12, operations to be executed by the driver (such as a steering operation and a direction indication operation) may be clarified by a leading vehicle image DSa, by adding a direction indication image DTa that looks like flashing of a direction indicator lamp for the direction of the change. Moreover, in a case where the vehicle is to be parked, as depicted in (b) of FIG. 12, a hazard image DTb that looks like flashing of a hazard lamp at the position of a vacant space is added, thereby enabling easy determination as to which position a vacant space is present at. Furthermore, in the case of low visibility, the color of a leading vehicle image DSa may be set in accordance with the inter-vehicle distance to a preceding vehicle. For example, as depicted in (c) of FIG. 12, when the inter-vehicle distance La to the preceding vehicle is equal to or longer than a predetermined distance Th, a leading vehicle image DSa-1 is displayed in a first color and, when the inter-vehicle distance La is shorter than the predetermined distance Th, a leading vehicle image DSa-2 is displayed in a second color. In this manner, the attribute of the leading vehicle image DSa is set in accordance with the inter-vehicle distance, thereby enabling prevention of excessive approach to the preceding vehicle due to the low visibility.

Incidentally, although the case where a leading vehicle image is used as the support image has been described in the above embodiment, the support image is not limited to the leading vehicle image. An image that facilitates recognition of information necessary for the driving, for example, information displayed by a traffic safety facility, and an image capable of preventing lowering of the attentiveness of the driver may be used.

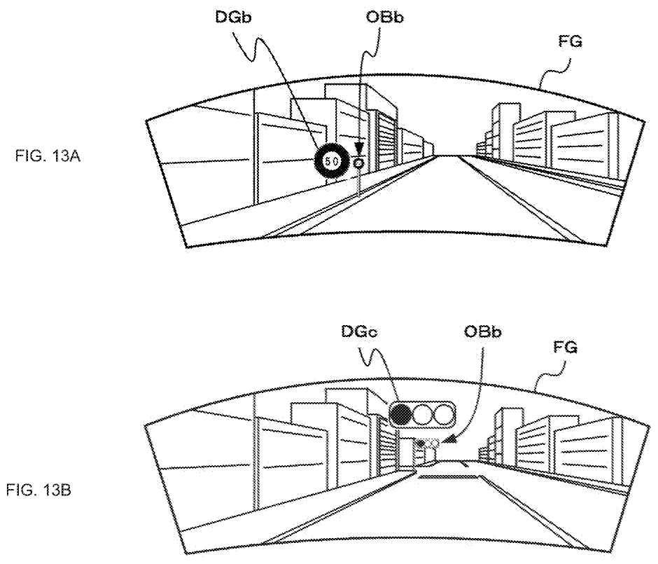

FIG. 13 exemplifies a case where a support image facilitating recognition of information necessary for driving is displayed. The microcomputer 7610 determines a traffic safety facility on the basis of, for example, a captured image captured by the imaging section 7910 or the imaging section 7918 depicted in FIG. 5. Moreover, the microcomputer 7610 displays a supplementary image emphasizing the display of the traffic safety facility as the support image on the windshield FG on the basis of the determination result. (a) of FIG. 13 depicts a case where a traffic sign OBb is determined, and the microcomputer 7610 displays a supplementary image DGb having the display content same as that of the determined traffic sign OBb at a position in the vicinity of the traffic sign OBb as the support image. (b) of FIG. 13 depicts a case where a traffic signal OBc is determined and the microcomputer 7610 displays a supplementary image DGc having the traffic signal state same as that of the determined traffic signal OBc, at a position in the vicinity of the traffic sign OBb as the support image. The display of the supplementary image is executed using the position of the determined traffic safety facility as the criterion, and the supplementary image is displayed at, for example, a position on the side opposite to the side of the road with respect to the traffic safety facility such that the forward field of view is not to be blocked. Moreover, when the supplementary image is displayed at a position close to the traffic safety facility, it can easily be determined which traffic safety facility the information indicated by the supplementary image is information relating to. The supplementary image emphasizing the display of the traffic safety facility is displayed in this manner, and easy determination is thereby enabled as to what display is executed even in a case where the display of the traffic safety facility is difficult to be seen due to, for example, backlight. Note that the supplementary image emphasizing the display of the traffic safety facility is not limited to the image indicating the content of the traffic sign or the traffic signal and may be, for example, an image supplementing a missing portion of a white line drawn on the road or the like.

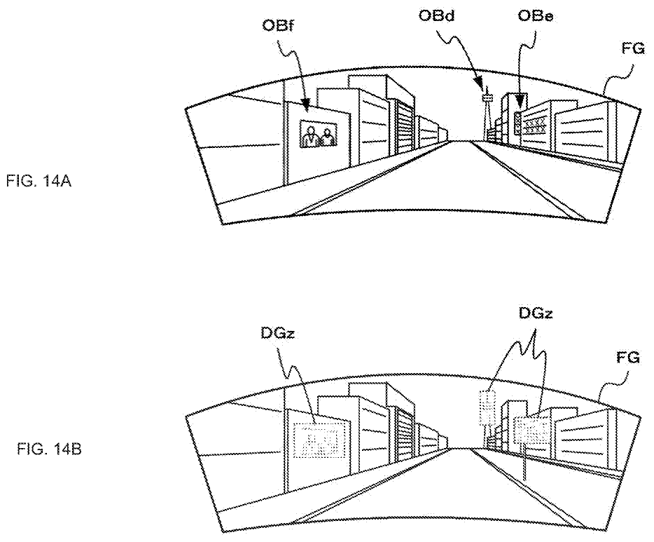

FIG. 14 exemplifies a case where a support image capable of preventing lowering of the attentiveness of the driver is displayed. The microcomputer 7610 detects an outside-vehicle object that may cause lowering of the attentiveness of the driver on the basis of, for example, the location information indicating the current location acquired by the positioning section 7640, the map information stored in the storage section 7690, and information and images acquired from external devices using the general-purpose communication I/F 7620 and the dedicated communication I/F 7630, and the like. The microcomputer 7610 displays a filter image that lowers the visibility of the outside-vehicle object as the support image so as to avoid lowering of the attentiveness of the driver due to the detected outside-vehicle object. (a) of FIG. 14 exemplifies a state before the support image is displayed and depicts, for example, a tourist facility OBd, a signboard OBe, a billboard apparatus OBf, and the like as the outside-vehicle object that may cause lowering of the attentiveness of the driver. The microcomputer 7610 displays the support image that lowers the visibility of the outside-vehicle object at the position of the detected outside-vehicle object, so that the attention of the driver is not directed toward the detected outside-vehicle object. In (b) of FIG. 14, the visibility of the detected tourist facility OBd, signboard OBe, and billboard apparatus OBf is lowered using filter images DGz as the support image. An image with which the detected outside-vehicle object is seen blurred, a semi-transmissible image that causes the detected outside-vehicle object to be difficult to be seen, a masking image that causes the detected outside-vehicle object to be invisible, and the like are used each as the filter image. In this manner, a support image that lowers the visibility is displayed at the position corresponding to an outside-vehicle object that may cause lowering of the attentiveness of the driver, thereby enabling prevention of lowering of the attentiveness of the driver due to the outside-vehicle object not relating to the driving.

Note that the control for the display position of the support image and the display timing are not limited to those set in advance, and a configuration may be adapted in which they are automatically changed so as to be optimally set in accordance with the characteristics of the driver by machine learning or the like on the basis of the running history of the own vehicle. Moreover, the display of the support image is not limited to the one exemplified above. The display is not limited to the case where the support image is displayed on the windshield and, for example, the driving support may be executed by displaying the support image on the rear window at the time of backward driving.

The series of processes described in the present specification are executable by hardware, software, or a combined configuration of hardware and software. In a case where the processes are executed by software, a program recording therein a process sequence is installed in a memory in a computer incorporated in a dedicated hardware and is executed. Alternatively, the program can be installed in a general-purpose computer capable of executing various types of processes to be executed.

For example, the program can be recorded in advance in a hard disk, an SSD (Solid State Drive), or a ROM (Read Only Memory) as a storage medium. Alternatively, the program can be stored (recorded) temporarily or permanently in a removable recording medium such as a flexible disk, a CD-ROM (Compact Disc Read Only Memory), an MO (Magneto optical) disk, a DVD (Digital Versatile Disc), a BD (Blu-Ray Disc (registered trademark)), a magnetic disk, or a semiconductor memory card. Such a removable recording medium can be provided as so-called packaged software.

Moreover, in addition to installing from a removable recording medium to a computer, the program may be transferred in a wireless or wired manner from a download site to a computer through a network such as a LAN (Local Area Network) or the Internet. The computer can receive the program transferred in such a manner and can install the program into an incorporated recording medium such as a hard disk.

Note that the effects described in the present specification are merely exemplification and are not limitative, and any additional effects not described herein may be achieved. Moreover, the present technology should not be interpreted to be limited to the above embodiment of the technology. The embodiment of the technology discloses the present technology in the form of exemplification and it is obvious that those skilled in the art can make modifications and substitutions to the embodiment within the scope not departing from the gist of the present technology. In other words, to determine the gist of the present technology, the appended claims should be referred to.

Moreover, the driving support apparatus of the present technology can also take the following configurations.

(1) A driving support apparatus including:

a situation determining section determining a situation of a vehicle on the basis of driving information;

a support image setting section setting a support image in accordance with a determination result obtained by the situation determining section; and

a display control section executing display control for displaying the support image set by the support image setting section on a window glass of the vehicle in accordance with the determination result obtained by the situation determining section.

(2) The driving support apparatus described in (1), in which

the display control section controls a display position of the support image in accordance with the determination result obtained by the situation determining section.

(3) The driving support apparatus described in (2), in which

the support image setting section sets a leading vehicle image as the support image in a case where the situation determining section determines that the vehicle is in a running operation, and

the display control section displays the leading vehicle image on a windshield of the vehicle.

(4) The driving support apparatus described in (3), in which

when the situation determining section determines that the vehicle is in a running operation using route information, the display control section controls the display position of the support image in accordance with the route information.

(5) The driving support apparatus described in (4), in which

the display control section controls the display position such that the leading vehicle image is at a position on a cruising lane based on the route information.

(6) The driving support apparatus described in (4) or (5), in which

the display control section controls the display position such that, at a road connection point associated with a right or left turn, or a change of a cruising lane, the leading vehicle image is at a position on a cruising lane taken when the right or left turn is made or on a changed cruising lane, on the basis of the route information.

(7) The driving support apparatus described in (6), in which

the display control section displays the leading vehicle image when a distance to the road connection point is within a predetermined range.

(8) The driving support apparatus described in any one of (3) to (7), in which

the driving information includes a running speed of the vehicle, and

the display control section moves a display position of the leading vehicle image in accordance with the running speed of the vehicle.

(9) The driving support apparatus described in any one of (3) to (8), in which

the driving information includes acceleration or deceleration information of the vehicle, and the driving support apparatus makes a setting of a size of the leading vehicle image in the support image setting section and/or controls a display position of the leading vehicle image in the display control section, in accordance with the acceleration or deceleration information.

(10) The driving support apparatus described in any one of (3) to (9), in which

the display control section displays the leading vehicle image in a case where a running location is within a predetermined zone.

(11) The driving support apparatus described in any one of (1) to (10), further including:

an outside condition determining section determining an outside condition on the basis of outside-vehicle information, in which

the support image setting section sets a support image in accordance with a determination result obtained by the situation determining section and/or the outside condition determining section, and

the display control section controls a display position of the support image in accordance with the determination result obtained by the situation determining section and/or the outside condition determining section.

(12) The driving support apparatus described in (11), in which

in a case where the situation determining section determines that the vehicle is in a running operation, the support image setting section sets a leading vehicle image as the support image, and

the display control section executes display control for the leading vehicle image on the basis of the outside condition determined by the outside condition determining section.

(13) The driving support apparatus described in (12), in which

the display control section determines a displayable area for the leading vehicle image on the basis of the outside condition determined by the outside condition determining section and displays the leading vehicle image in the determined displayable area.

(14) The driving support apparatus described in (12) or (13), in which

in a case where the situation determining section determines that the vehicle is entering a parking lot, the display control section displays the leading vehicle image at a position on a route to a vacant space in a parking area determined by the outside condition determining section.

(15) The driving support apparatus described in any one of (12) to (14), in which

in a case where the outside condition determining section determines that visibility is low, the display control section displays the leading vehicle image at a position on a cruising lane of the vehicle.

(16) The driving support apparatus described in (15), in which

the outside condition determining section determines an inter-vehicle distance to a preceding vehicle, and the driving support apparatus makes a setting of an attribute of the leading vehicle image in the support image setting section or controls a display position of the leading vehicle image in the display control section, in accordance with the determined inter-vehicle distance.

(17) The driving support apparatus described in any one of (11) to (16), in which

the outside condition determining section executes determination as to a traffic safety facility,

the support image setting section sets a supplementary image that emphasizes display of the traffic safety facility determined by the outside condition determining section, and

when the outside condition determining section determines the traffic safety facility, the display control section displays the supplementary image using a position of the determined traffic safety facility as a criterion.

(18) The driving support apparatus described in any one of (11) to (17), in which

in a case where the situation determining section determines that the vehicle is in a running operation, the support image setting section sets a filter image that lowers visibility as the support image,

the outside condition determining section executes determination as to an outside-vehicle object that may cause lowering of attentiveness of a driver, and

the display control section displays the filter image at a position of the outside-vehicle object determined by the outside condition determining section.

### INDUSTRIAL APPLICABILITY

According to the driving support apparatus and the driving support method of the present technology, the situation of the vehicle is determined by the situation determining section on the basis of the driving information, and a support image is set by the support image setting section in accordance with the determination result obtained by the situation determining section. Furthermore, the display control for the support image set by the support image setting section is executed by the display control section on an outside-vehicle visual recognition face of the vehicle in accordance with the determination result obtained by the situation determining section. The driving support can therefore be executed with a natural sense. The present technology is therefore applicable to various types of vehicles running on the roads.

### Reference Signs List

10 . . . Driving support apparatus
11 . . . Situation determining section
12 . . . Outside condition determining section
13 . . . Support image setting section
14 . . . Display control section
7000 . . . Vehicle control system
7110 . . . Vehicle state detecting section
7410 . . . Imaging section
7420 . . . Outside-vehicle information detecting section
7510 . . . Driver state detecting section
7610 . . . Microcomputer
7640 . . . Positioning section
7690 . . . Storage section
7720 . . . Display section
7900 . . . Vehicle
7910, 7912, 7914, 7916, 7918 . . . Imaging section

1. A driving support apparatus comprising:
a situation determining section determining a situation of a vehicle on a basis of driving information;
a support image setting section setting a support image in accordance with a determination result obtained by the situation determining section; and
a display control section executing display control for displaying the support image set by the support image setting section on a window glass of the vehicle in accordance with the determination result obtained by the situation determining section.

2. The driving support apparatus according to claim 1, wherein
the display control section controls a display position of the support image in accordance with the determination result obtained by the situation determining section.

3. The driving support apparatus according to claim 2, wherein
the support image setting section sets a leading vehicle image as the support image in a case where the situation determining section determines that the vehicle is in a running operation, and
the display control section displays the leading vehicle image on a windshield of the vehicle.

4. The driving support apparatus according to claim 3, wherein
when the situation determining section determines that the vehicle is in a running operation using route information, the display control section controls the display position of the support image in accordance with the route information.

5. The driving support apparatus according to claim 4, wherein
the display control section controls the display position such that the leading vehicle image is at a position on a cruising lane based on the route information.

6. The driving support apparatus according to claim 4, wherein
the display control section controls the display position such that, at a road connection point associated with a right or left turn, or a change of a cruising lane, the leading vehicle image is at a position on a cruising lane taken when the right or left turn is made or on a changed cruising lane, on a basis of the route information.

7. The driving support apparatus according to claim 6, wherein
the display control section displays the leading vehicle image when a distance to the road connection point is within a predetermined range.

8. The driving support apparatus according to claim 3, wherein
the driving information includes a running speed of the vehicle, and
the display control section moves a display position of the leading vehicle image in accordance with the running speed of the vehicle.

9. The driving support apparatus according to claim 3, wherein
the driving information includes acceleration or deceleration information of the vehicle, and the driving support apparatus makes a setting of a size of the leading vehicle image in the support image setting section and/or controls a display position of the leading vehicle image in the display control section, in accordance with the acceleration or deceleration information.

10. The driving support apparatus according to claim 3, wherein
the display control section displays the leading vehicle image in a case where a running location is within a predetermined zone.

11. The driving support apparatus according to claim 1, further comprising:
an outside condition determining section determining an outside condition on a basis of outside-vehicle information, wherein
the support image setting section sets a support image in accordance with a determination result obtained by the situation determining section and/or the outside condition determining section, and
the display control section controls a display position of the support image in accordance with the determination result obtained by the situation determining section and/or the outside condition determining section.

12. The driving support apparatus according to claim 11, wherein
in a case where the situation determining section determines that the vehicle is in a running operation, the support image setting section sets a leading vehicle image as the support image, and
the display control section executes display control for the leading vehicle image on a basis of the outside condition determined by the outside condition determining section.

13. The driving support apparatus according to claim 12, wherein
the display control section determines a displayable area for the leading vehicle image on the basis of the outside condition determined by the outside condition determining section and displays the leading vehicle image in the determined displayable area.

14. The driving support apparatus according to claim 12, wherein
in a case where the situation determining section determines that the vehicle is entering a parking lot, the display control section displays the leading vehicle image at a position on a route to a vacant space in a parking area determined by the outside condition determining section.

15. The driving support apparatus according to claim 12, wherein
in a case where the outside condition determining section determines that visibility is low, the display control section displays the leading vehicle image at a position on a cruising lane of the vehicle.

16. The driving support apparatus according to claim 15, wherein
the outside condition determining section determines an inter-vehicle distance to a preceding vehicle, and the driving support apparatus makes a setting of an attribute of the leading vehicle image in the support image setting section or controls a display position of the leading vehicle image in the display control section, in accordance with the determined inter-vehicle distance.

17. The driving support apparatus according to claim 11, wherein
the outside condition determining section executes determination as to a traffic safety facility,
the support image setting section sets a supplementary image that emphasizes display of the traffic safety facility determined by the outside condition determining section, and
when the outside condition determining section determines the traffic safety facility, the display control section displays the supplementary image using a position of the determined traffic safety facility as a criterion.

18. The driving support apparatus according to claim 11, wherein
in a case where the situation determining section determines that the vehicle is in a running operation, the support image setting section sets a filter image that lowers visibility as the support image,
the outside condition determining section executes determination as to an outside-vehicle object that may cause lowering of attentiveness of a driver, and
the display control section displays the filter image at a position of the outside-vehicle object determined by the outside condition determining section.

19. A driving support method comprising:
by a situation determining section, determining a situation of a vehicle on a basis of driving information;
by a support image setting section, setting a support image in accordance with a determination result obtained by the situation determining section; and
by a display control section, executing display control for displaying the support image set by the support image setting section on a window glass of the vehicle in accordance with the determination result obtained by the situation determining section.
